(19) United States
(12) Patent Application Publication
(10) Pub. No.: US 2009/0245265 A1
(43) Pub. Date: Oct. 1, 2009

(54) COMMUNICATION GATEWAY DEVICE AND RELAY METHOD OF THE SAME

(76) Inventors: Yoshiteru TAKESHIMA, Tokyo (JP); Masahiko Nakahara, Machida (JP)

Correspondence Address: MCDERMOTT WILL & EMERY LLP, 600 13TH STREET, N.W., WASHINGTON, DC, 20005-3096, US

(21) Appl. No.: 12/366,069

(22) Filed: Feb. 5, 2009

(30) Foreign Application Priority Data
Feb. 5, 2008 (JP) 2008-025023

(51) Int. Cl. H04L 12/56; G06F 15/16

(52) U.S. Cl. 370/401; 709/228

(57) ABSTRACT

To continue communication of a client even if an SIP server falls into a congestion state. Each of a communication gateway device and a relay method of the present invention couples to a client device and to an SIP server device for managing coupling information of the client device via a network; stores SIP-URI and a contact address of the client device that are included in a REGISTER request from the client device to the SIP server device as setup information; and when receiving an INVITE request from the client device to another client device, that is an SIP method for beginning a session, refers to the setup information, and forwards the INVITE request to the other client device.

### INCORPORATION BY REFERENCE

This application claims priority based on a Japanese patent application, No. 2008-025023 filed on Feb. 5, 2008, the entire contents of which are incorporated herein by reference.

### BACKGROUND OF THE INVENTION

The present invention relates to a communication gateway device for relaying communication data between a client and a server, and a relay method thereof.

In recent years, communication applications that adopt SIP (Session Initiation Protocol) are coming into widespread use (see Patent Documents 1 and 2). An IP phone using the SIP is a main application in the next-generation telecom network called NGN (Next Generation Network), and particular importance is attached to stabilization of the system. Especially, the stabilization of a server for managing IP addresses of IP phone clients, called SIP server, at the time of a heavy load has become a problem.

As a method for avoiding service failure due to congestion of the SIP server, there is a method wherein the SIP server detects the failure of an opposed SIP server and bypasses data to another SIP server (e.g., Japanese Unexamined Patent Application Publication No. 2004-179764).

Moreover, as another method for this, there is a method of alleviating a load to the SIP server by a load balancer (e.g., Japanese Unexamined Patent Application Publication No. 2007-60210).

### SUMMARY OF THE INVENTION

However, the above-mentioned method may cause a failure in the another SIP server to which the load is bypassed if the SIP server has the same fault, and as a result there is a risk of making the service to the client devices turn off totally.

The present invention provides a communication gateway device that enables clients to continue communication even if SIP server falls into a congestion state.

The communication gateway device of the disclosed system has (1) a storage device that couples to the client device and an SIP server device for managing coupling information of the client device via the network and that stores setup information including SIP-URI and a contact address of the client device included in a REGISTER request from the client device to the SIP server device that is the SIP method for registering the client device with the SIP server device and (2) the communication proxy processing unit that, in response to reception of an INVITE request, from the client device to an other client device, that is the SIP method for beginning a session, refers to the setup information, and forwards the INVITE request to the other client device.

The communication gateway device of the disclosed system further stores mapping information in the storage device, the mapping information in which information about the SIP-URI of the client device included in the REGISTER request and the communication gateway device taking charge of the client device are associated with each other. The communication gateway device refers to the mapping information, and when another communication gateway device takes charge of the client device having transmitted the REGISTER request, forwards the REGISTER request to another communication gateway device.

The communication gateway device of the disclosed system further stores state information of the SIP server device in the storage device. The communication gateway device, when receiving the INVITE request from a client device to another client device, if the state information indicates a congestion state of the SIP server device, refers to mapping information, and in the case where another communication gateway device takes charge of the other client device, forwards the INVITE request to another communication gateway device.

According to the teaching herein, even if the SIP server falls into a congestion state, communication of the client whose coupling information is cached by the communication gateway device can be continued.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram showing an example of a configuration of a communication system that couples a communication gateway of a first embodiment.

FIG. 2 is a diagram illustrating a processing flowchart at the time of receiving an SIP request that will be executed by the communication gateway.

FIG. 3 is a diagram illustrating a processing flowchart at the time of receiving a REGISTER request that will be executed by the communication gateway.

FIG. 4 is a diagram illustrating a processing flowchart at the time of receiving an INVITE request that will be executed by the communication gateway.

FIG. 5 is a diagram illustrating a processing sequence of the REGISTER request.

FIG. 6 is a diagram illustrating a processing sequence of the INVITE request.

FIG. 7 is a diagram showing an example of a hardware configuration of the communication gateway.

FIG. 8 is a diagram showing an example of a configuration of a communication system of a second embodiment.

FIG. 9 is a diagram showing an example of a mapping table storage part of the communication gateway.

FIG. 10 is a diagram showing an example of a server state storage part of the communication gateway.

FIG. 11 is a diagram showing an example of a cache data storage part of the communication gateway.

### DETAILED DESCRIPTION OF THE EMBODIMENTS

Hereafter, the best modes for carrying out a communication gateway device of the present invention and a relay method thereof will be described using embodiments.

### First Embodiment

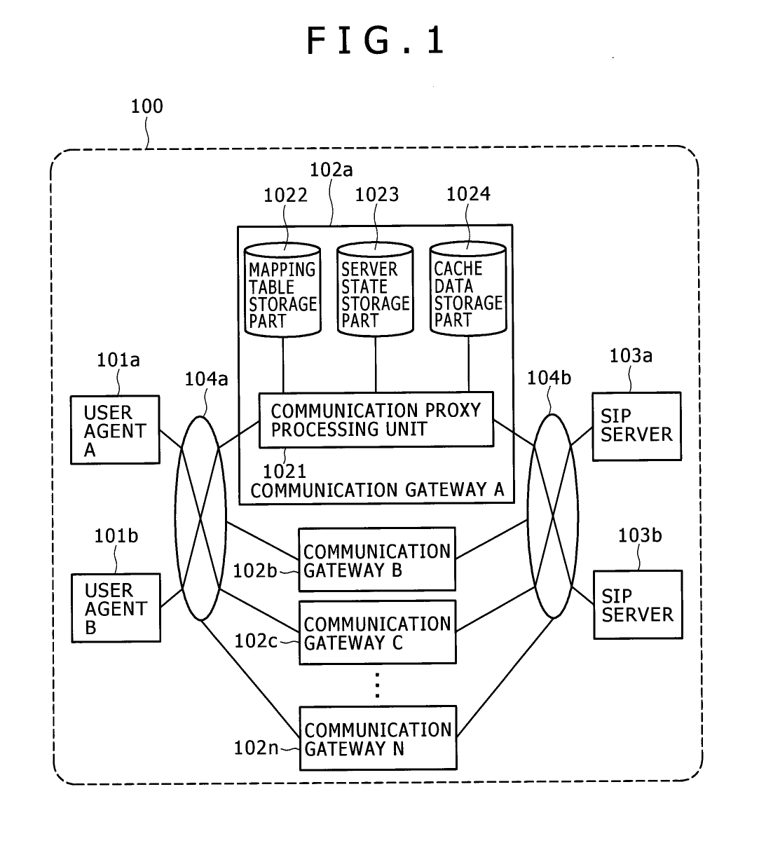

FIG. 1 is an example of a configuration of a communication system 100 that couples to communication gateways 102 (102a, 102b, . . . , 102n) of this embodiment. As is shown in the figure, the communication system 100 has user agents (client devices) 101 (101a, 101b), the communication gateways 102, and SIP servers 103 (103a, 103b). The user agents 101 couple to a network 104a, the SIP servers 103 couple to a network 104b, and these devices communicates mutually via the communication gateways 102 for relaying communication between the network 104a and the network 104b.

Here, the user agents 101 are client devices that communicate with other user agents 101 using SIP (Session Initiation Protocol). For example, they are IP phones etc. A user agent A 101a needs to acquire an IP address of the user agent B 101b that is a communication partner. The SIP servers 103 are servers each for managing an IP address of each user agent 101.

The user agent 101, when coupling to the network 104a, notifies the SIP server 103 of its IP address using a REGISTER method (this is a method prepared to enable a client make login and register its address in an SIP server, being called a REGISTER request). Then, when the user agent 101 does communication, it transmits the INVITE method (this is a method to begin a session, a method of SIP including information of the communication partner, being called an INVITE request) to the SIP servers 10, and gets the SIP server 103 to respond thereto with an IP address of the communication partner.

The communication gateway 102 that makes the user agents 101 and the SIP servers 103 logically couple to one another via the network 104 has a communication proxy processing unit 1021, a mapping table storage part 1022, a server state storage part 1023, and a cache data storage part 1024. The communication proxy processing unit 1021 is implemented as a program that is executed by a CPU (processor) described later.

The communication proxy processing unit 1021 performs processing as an SIP proxy server (a request from the client is forwarded to an appropriate SIP server). When the SIP server 103 is behindhand in response due to a heavy load, a failure, etc., the communication proxy processing unit 1021 grasps states of the SIP servers 103, searches the local and other communication gateways 102 that have IP address information of the user agent 101 of the communication partner in their caches, and forwards an SIP request to the communication gateway 102. The communication gateway 102 to which the SIP request was forwarded communicates with the user agent 101 that is the communication partner instead of the SIP server that is behindhand in response.

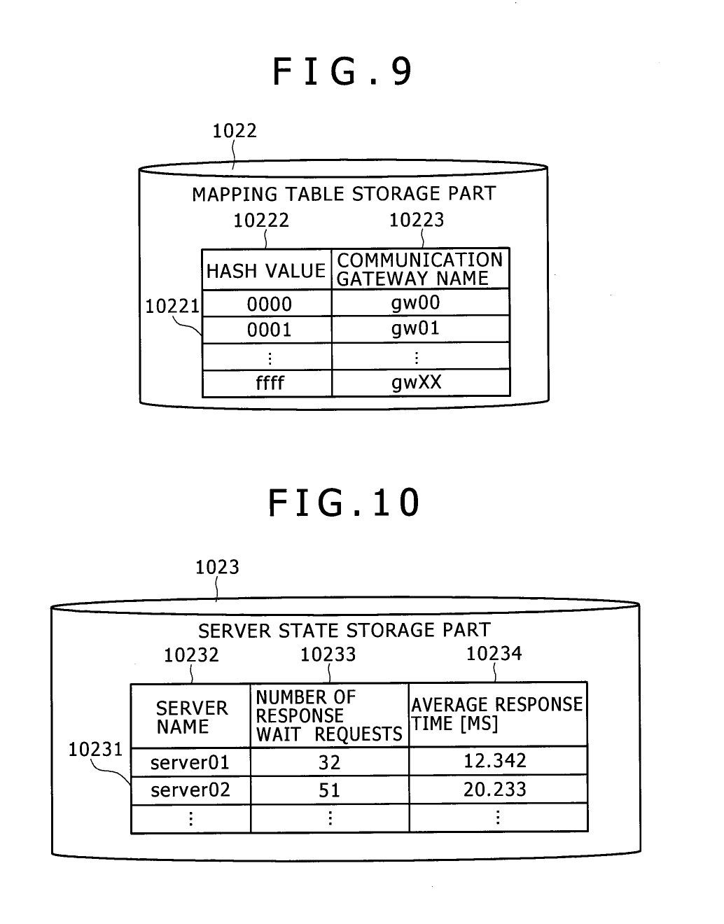

The mapping table storage part 1022 is an area for storing a mapping table that associates SIP URI (Uniform Resource Identifier) for identifying the user uniquely and the communication gateway 102 for managing cache of the SIP-URI with each other. FIG. 9 shows an example of the mapping table storage part 1022. The mapping table storage part 1022 stores a mapping table 10221. The mapping table 10221 is a table for managing a hash value 10222 and a host name 10223 of the communication gateway 102 (communication gateway name) corresponding to the hash value in a table format. In this example, it is assumed that the size of hash space is 16 bits (0000 to ffff).

The server state storage part 1023 is an area for storing the response state of the SIP server 103. FIG. 10 shows an example of the server state storage part 1023. The server state storage part 1023 stores the server state management table 10231. The server state management table 10231 is a table for managing a host name (server name) of the SIP server 103 and the response state of the SIP request that was transmitted to the SIP server 103. The response state of the SIP server 103 includes the number of waiting response requests 10233 to the SIP server 103 and an average response time 10234. FIG. 10 shows the number of waiting response requests 10233 and the average response time 10234. If there is information of at least one of the two, it is sufficient as information indicating the state of the SIP server 103.

The number of waiting response requests indicates the number of the SIP requests each of which was forwarded to the SIP server 103 but is in a state of waiting the response. At a time when the SIP request is transmitted to the SIP server 103, this value is increased (being counted up). This value is decreased (being counted down) at a time when the SIP response is received from the SIP server 103 or when there is no SIP response from the SIP server 103 and session time-out occurs after elapse of a predetermined time.

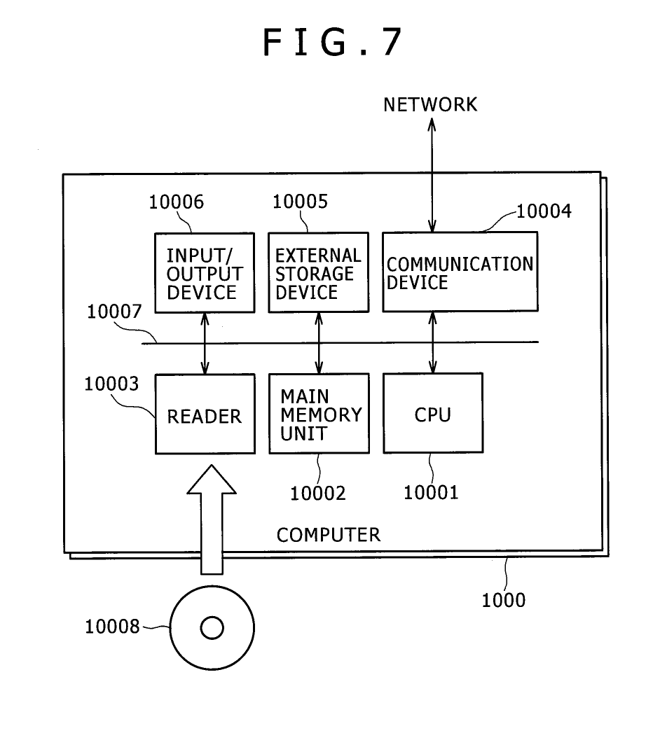

The average response time is computed for an average value of response times, the response time being from when the communication gateway 102 transmits the SIP request to the SIP server 103 to when its SIP response is sent back. In this embodiment, it is expressed in milliseconds. The calculation method is conducted as follows, for example: (1) the communication proxy processing unit 1021 measures a duration (response time) from a time of transmitting the SIP request to the SIP server 103 to a time of receiving the SIP response responding to that SIP request from the SIP server 103 or measures a time-out time when time-out occurs, and the measurement result is stored in a main memory unit 10002 (which will be described later using FIG. 7), and (2) it computes an average value of all response times (that are stored in the main memory unit 10002) at regular intervals. When this method is used, if all SIP responses that are to be measured in a fixed interval go time-out, the average response time will be equal to a predetermined time that is set as a time-out time.

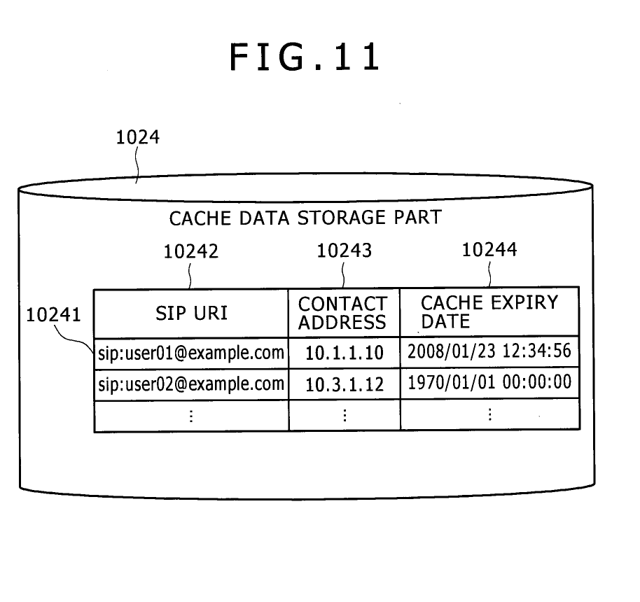

The cache data storage part 1024 is an area for storing an IP address (a contact address) of the user agent 101 that is a transmission source of the REGISTER request. FIG. 11 shows an example of the cache data storage part 1024. The cache data storage part 1024 stores cache data 10241 of coupling information of the user agents 101. The coupling information stored in the cache data 10241 is SIP-URI 10242 of the user, a contact address 10243, and cache expiry date 10244 of the transmission source of the REGISTER request.

SIR-URI described in the From header (an area indicating a transmission source of the request) of the REGISTER request that the user agent 101 of the transmission source of the REGISTER request transmitted to the communication gateway 102 is stored in the area of the SIP-URI 10242. An IP address described in the Contact header (an area showing the contact address of the user) of the REGISTER request is stored in an area of the contact address 10243 (here, an IP address described in the Contact header of “200 OK” response sent back from the SIP server 103 to the REGISTER request may be stored in the area of the contact address 10243). In the area of the cache expiry date 10244, expiry time and date of the cache that is the OK response reception time added with a term of validity specified by the expires header included in the Contact header of the “200 OK” response from the SIP server 103 responding to the REGISTER request from the user agent 101 is stored.

The communication proxy processing unit 1021 invalidates this cache data 10241 on an entry basis after time and date of the cache expiry date 10244 expires. Incidentally, the contact address 10243 may not necessarily be an IP address, but may be SIP-URI including the host name that can reach the user finally.

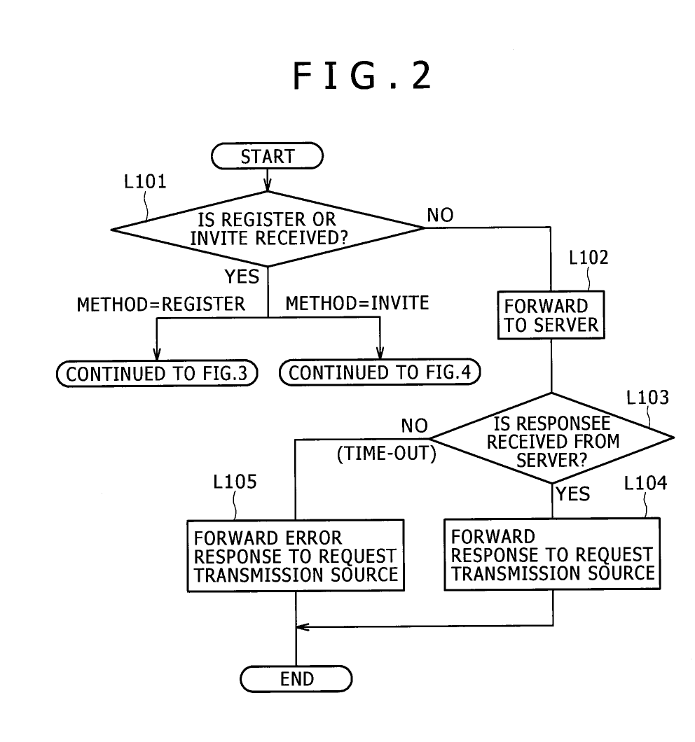

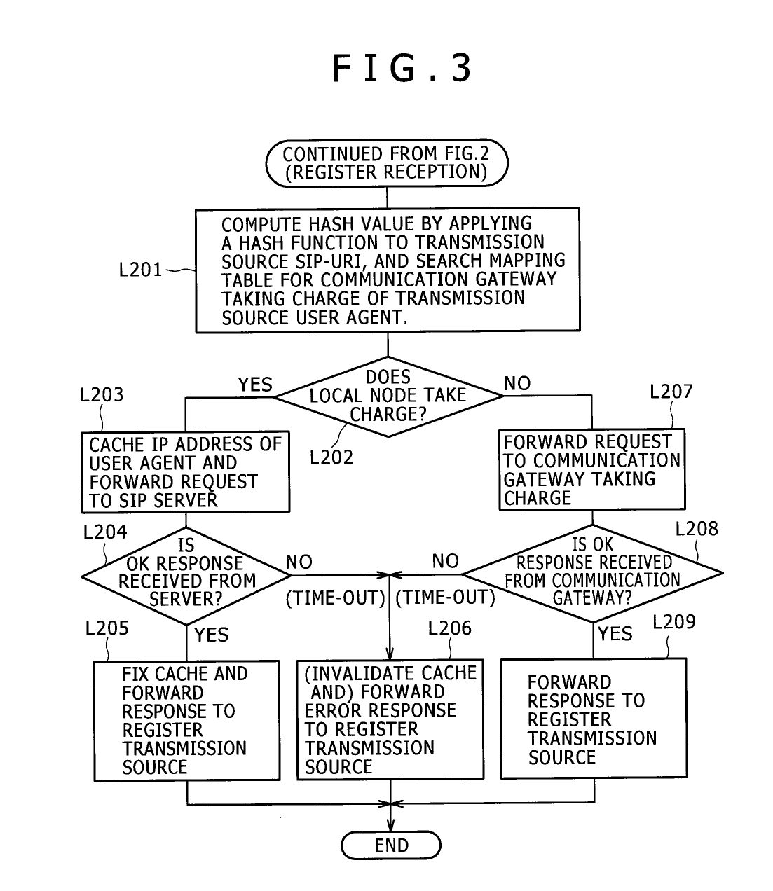

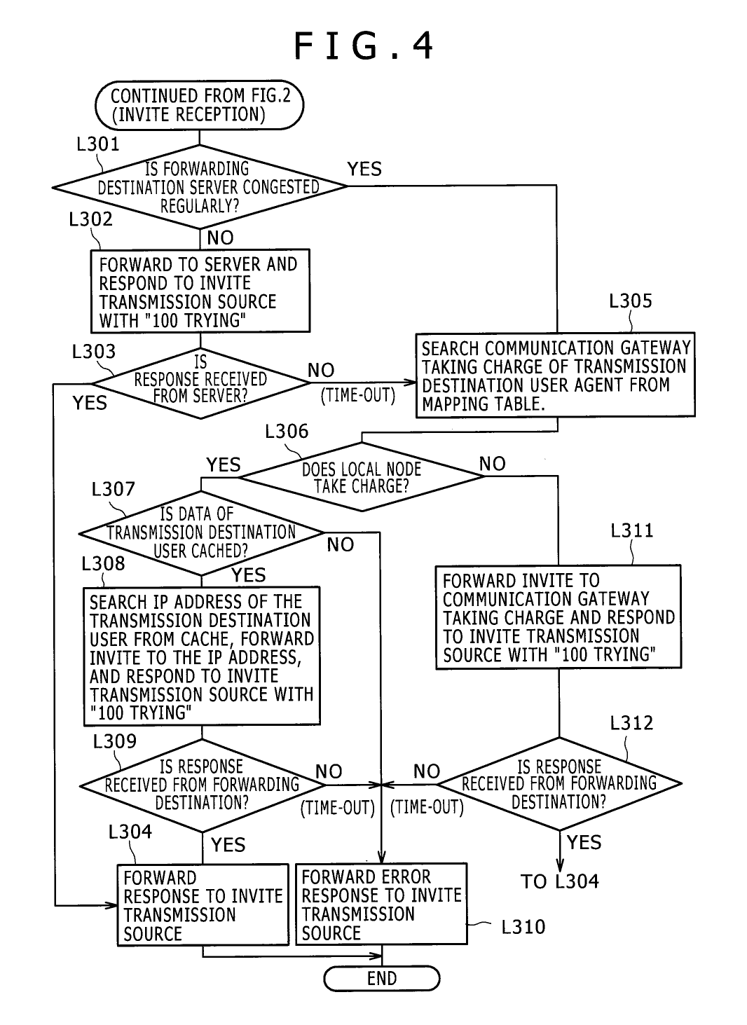

FIG. 2 is a flowchart showing a processing when the communication proxy processing unit 1021 receives the SIP request. On receipt of the SIP request, the communication proxy processing unit 1021 will determine which one it is, the REGISTER request, the INVITE request, or another SIP request (L101). A processing in the case of the REGISTER request will be described later using FIG. 3. A processing in the case of the INVITE request will be described later using FIG. 4.

If a request is another request that is neither the REGISTER request nor the INVITE request, the received SIP request will be forwarded to the SIP servers 103 like the general SIP proxy server (L102). At that time, a communication timer (WAIT timer) is activated. A response from the SIP server 103 is monitored (L103). If the response is received without the communication timer going time-out, the response received from the SIP server 103 will be forwarded to an SIP request transmission source (L104). When the communication timer goes time-out, the communication proxy processing unit 1021 responds to the SIP request transmission source (L105) with an error response.

FIG. 3 is a flowchart showing a processing when the communication proxy processing unit 1021 receives the REGISTER request. The communication proxy processing unit 1021 computes a hash value by applying a hash function to a transmission source SIP-URI described in the message of the REGISTER request, searches the mapping table 10221 maintained in the mapping table storage part 1022 using the hash value as a search key, and finds the host name of the communication gateway 102 taking charge of the cache of the transmission source SIP-URI (L201).

As the hash function, MD5 (Message Digest Algorithm 5) may be used, for example, and other hash functions may be used. The hash function (MD5 etc.) is multiplied by the SIP-URI to compute the hash value (hexadecimal) and the last four figures are extracted. Then, the host name of the communication gateway 102 corresponding to the extracted hash value (last four figures) is obtained referring to the mapping table 10221 of FIG. 9.

It is determined whether the local communication gateway is the communication gateway 102 taking charge of the transmission source SIP-URI (L202) as a result of the search. If the local communication gateway 102 is in charge, the communication proxy processing unit 1021 caches the SIP-URI and the IP address of the transmission source user agent 101 included in the REGISTER request, in the SIP-URI area 10242 and the contact address area 10243 of the cache data storage part 1024, and forwards the REGISTER request to the SIP server 103 to activate the communication timer (WAIT timer) (L203). However, the data that is cached here is not yet considered final, and even if the cache is searched for the data at this time, it will be not used.

After forwarding the REGISTER request to the SIP servers 103, the communication proxy processing unit 1021 monitors reception of the OK response from the SIP server 103 (L204). When receiving the OK response, the communication proxy processing unit 1021 computes expiry time and date of the cache by adding a term of validity specified by an expires header of a Contact header in the OK response to OK response reception time and date, stores the time and date in the cache expiry date area 10244 of the cache data storage part 1024, considers the cached data to be final, and forwards the response from the SIP server 103 to the REGISTER request transmission source (L205). Whether the cached data is fix data can be determined by whether future time and date after the present time and data is stored in the cache expiry date area 10244 as expiry time and date. When reception of other than OK response or time-out occurs, it invalidates the cached data, stores an invalid time and date, for example, a past time and date such as 1970/01/01 00:00:00 in the cache expiry date area 10244, and transmits the error response to the REGISTER request transmission source (L206).

If the other communication gateway 102 is in charge as a result of determination of L202, the communication proxy processing unit 1021 will forward the REGISTER request to the applicable communication gateway 102 (L207). After forwarding the REGISTER request to the other communication gateway 102, the communication proxy processing unit 1021 monitors reception of the OK response from the other communication gateway 102 that is a forwarding destination of the REGISTER request (L208). When receiving the OK response, it forwards the OK response to the REGISTER request transmission source (L209). When it receives other than the OK response or time-out occurs, it transmits the error response to the REGISTER request transmission source (L206).

FIG. 4 is a flowchart showing a processing when the communication proxy processing unit 1021 received the INVITE request. The communication proxy processing unit 1021 obtains a forwarding destination SIP server name from the SIP-URI of the SIP server described in the message of the received INVITE request, acquires a state of the forwarding destination SIP server 103 from the server state storage part 1023, and determines whether the forwarding destination SIP server 103 is congested regularly (L301). A method for determining whether the state of the forwarding destination SIP server 103 is behindhand regularly, the so-called method for determining a congestion state determines, for example, whether the average response time of the SIP server 103 or the number of waiting response coupling exceeds a threshold being set in advance in the communication proxy processing unit 1021. If both of them do not exceed thresholds, it is regarded that the forwarding destination SIP server 103 is not behindhand. If either exceeds the threshold, it is regarded that the forwarding destination SIP server 103 is behindhand.

If the forwarding destination SIP server 103 is not behindhand, the communication proxy processing unit 1021 will forward the INVITE request to the forwarding destination SIP server 103, will activate the communication timer (WAIT timer), and will respond to the transmission source of the INVITE request with “100 Trying” (a response for notifying the transmission source that the INVITE request has been received and is being processed) (L302). After forwarding the INVITE request to the forwarding destination SIP server 103, it monitors reception of the response from the forwarding destination SIP server 103 (L303). When receiving the response, it forwards the response to the transmission source of the INVITE request (L304).

When it is determined that the forwarding destination SIP server 103 is regularly congested at Step L301, or when time-out occurs at Step L303, the communication proxy processing unit 1021 searches the mapping table maintained in the mapping table storage part 1022 using the hash value obtained from transmission destination SIP-URI included in a message of the INVITE request as a search key to find the communication gateway 102 taking charge of the transmission destination SIP-URI (L305).

It is determined whether the local communication gateway is the communication gateway 102 taking charge of the transmission source SIP-URI, as a result of the search (L306). If the local communication gateway 102 is in charge, the communication proxy processing unit 1021 searches the cache data of the cache data storage part 1024 from the SIP-URI of the transmission destination user agent 101 included in the message of the INVITE request (L307), acquires an IP address of the transmission destination user agent 101, forwards the INVITE request to the transmission destination user agent having this IP address, activates the communication timer (WAIT timer), and responds to the transmission source of the INVITE request with “100 Trying” (L308).

After forwarding the INVITE request to the transmission destination user agent 101, the communication proxy processing unit 1021 monitors reception of the response from the transmission destination user agent 101 (L309). When receiving the response, it forwards the response to the transmission source of the INVITE request (L304). When time-out occurs, the communication proxy processing unit 1021 transmits the error response to the transmission source of the INVITE request (L310).

If the other communication gateway 102 is in charge as a result of determination of Step L306, it forwards the INVITE request to the other communication gateway 102 that is in charge, activates the communication timer (WAIT timer), and responds to the transmission source of the INVITE request with “100 Trying” (L311). After forwarding the INVITE request to the other communication gateway 102, it monitors reception of the response from the other communication gateway 102 (L312). When receiving the response, it forwards the response to the transmission source of the INVITE request (L304). When time-out occurs, the communication proxy processing unit 1021 transmits the error response to the transmission source of the INVITE request (L310).

FIG. 7 shows an example of a hardware configuration of the communication gateway 102. The communication gateway 102 can be realized with a general computer 1000 that has: a CPU 10001; the main memory unit 10002; an external storage device 10005, such as HDD; a reader 10003 for reading information from a storage media 10008 having portability, such CD-ROM and DVD-ROM; an input/output device 10006, such as a display, a key board, and a mouse; a communication device 10004 for coupling to a communication network, such as NIC (Network Interface Card); and a bus 10007 for data forwarding between these devices.

For example, the mapping table storage part 1022 is realized using a part of an area of the main memory unit 10002. The communication proxy processing unit 1021 loads a communication proxy processing program stored in the external storage 10005 into the main memory unit 10002, executes it in the CPU 10001, and realizes a network communication with the user agents 101 and the servers 103 via the communication device 10004.

It is all right that the system is configured so as to download the communication processing program from the storage media 10008 via the reader 10003 or from the network via the communication device 10004 to the external storage 10005, to load it into the main memory unit 10002, and to make the CPU 10001 execute it. Alternatively, it is also all right that the system is configured so as to directly load the communication processing program from the storage media 10008 via the reader 10003 or from the network via the communication device 10004 into the main memory unit 10002, and to make the CPU 10001 execute it.

By the configuration as described above, this communication gateway 102 can continue a communication service in the maximum effort type by caching information such as an IP address of the user agent 101 and making a response using the contents of the cache at the time of response delay due to a failure of the SIP server 103 etc.

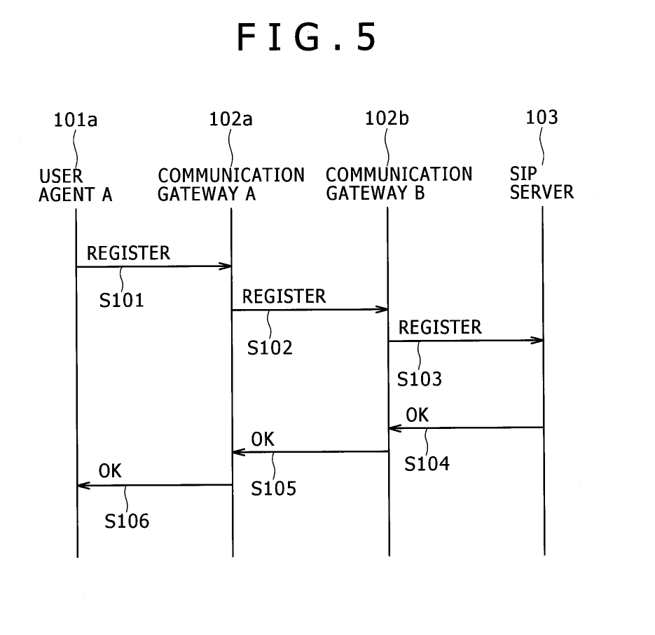

FIG. 5 is a diagram showing a processing sequence in which the user agent A 101a registers its own IP address with the SIP server 103 (to do the REGISTER request), which was already explained. The user agent A 101a transmits its own IP address to the communication gateway 102a by the REGISTER request (S101). A communication gateway A 102a forwards the REGISTER request to the communication gateway B 102b taking charge of the user agent A 101a (S102).

The communication gateway B 102b that received the REGISTER request from the communication gateway A 102a forwards the REGISTER request to the SIP server 103 (S103). The SIP server 103 makes the management database reflect the IP address of the user agent A 101a that is the transmission source.

The communication gateway B 102b that received the OK response from the SIP servers 103 (S104) forwards the response to the communication gateway A 102a (S105). The communication gateway B 102b is caching the IP address of the user agent A 101a that is the transmission source of the REGISTER request. The communication gateway A 102a that received the OK response from the communication gateway B 102b forwards the response to the user agent A 101a (S106).

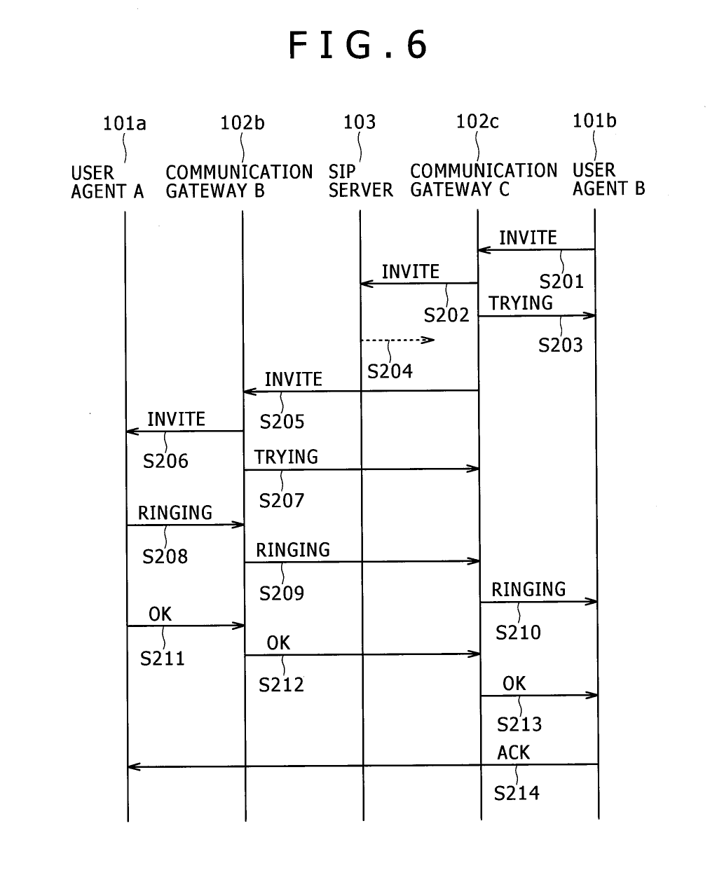

FIG. 6 is a diagram showing a processing sequence in which the user agent B 101b makes the INVITE request to the user agent A 101a in order to start communication. Here, it is assumed that at initial time, delay has not occurred in the SIP server 103.

To a communication gateway C102c, the user agent B 101b transmits the INVITE request to the user agent A 101a (S201). The communication gateway C102c forwards the INVITE request to the SIP server 103 maintaining the IP address information of the user agent A 101a (S202), and responds to the user agent B 101b with “100 Trying” (a response for notifying the device of the preceding stage that the message has been received) (S203).

It is assumed that at this time, a failure occurs in the SIP server 103, which falls into a response disable state (S204). At Step L303 of FIG. 4, in the communication gateway C102c, waiting response time-out of the SIP server 103 occurs. Because of this, the communication gateway C102c searches the communication gateway 102 taking charge of the user agent A 101a at Step L305 to find the communication gateway B 102b. Then, it forwards the INVITE request to the communication gateway B 102b (S205).

The communication gateway B 102b searches the communication gateway 102 taking charge of the user agent A 101a, and finds that the local node (the communication gateway B 102b) is in charge. Then, it acquires the IP address information of the user agent A 101a that is cached at Step S102 of FIG. 5, forwards the INVITE request to this IP address (=the user agent A 101a) (S206), and responds to the communication gateway C102c with “100 Trying” (S207). Henceforth, since Steps S208 to S214 are a general SIP sequence, they are omitted. Incidentally, Ringing at Step S208 is a response for notifying the transmission source user agent 101b that the transmission destination user agent A 101a is being called.

### Second Embodiment

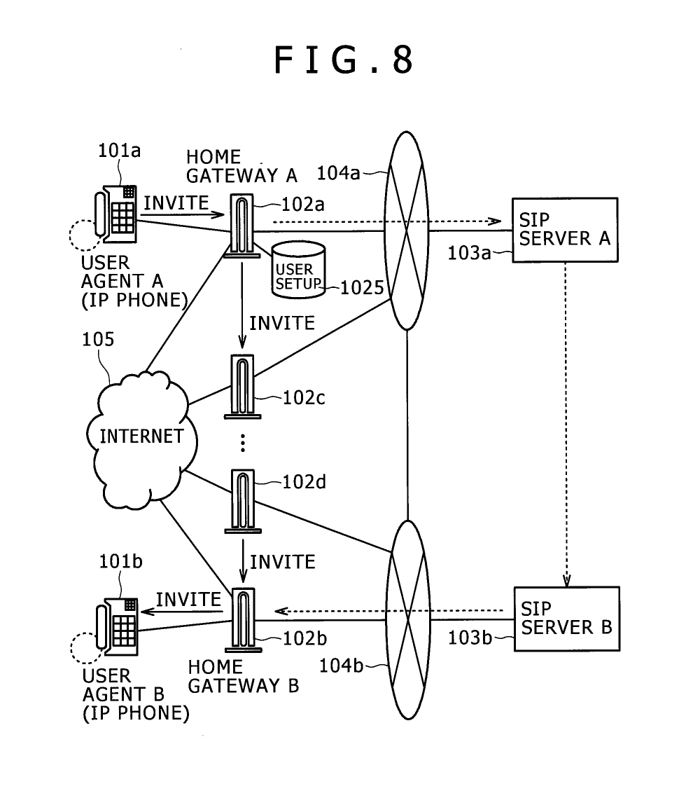

FIG. 8 is a diagram showing a communication system of a second embodiment. The communication system of this embodiment does not use the SIP servers 103 but uses communication gateways for communication with the specific user agent that is an object of the INVITE request. The communication with the specific user agent is, for example, a communication with the user agent such that its line quality is not good and low communication reliability is acceptable.

A communication system shown in FIG. 8 consists of the IP phones (101a, 101b) as user agents, home gateways as the communication gateways (102a to 102d), the SIP servers (103a, 103b), the networks (104a, 104b), and a network (for example, Internet) 105 whose communication reliability is lower than that of the network 104.

The home gateway 102 maintains a user setup 1025 in its internal memory. The user setup 1025 is, for example, a telephone number of a call destination whose telephone call quality by the IP phone need not be high. The user is expected to set this user setup 1025 in advance.

When receiving the INVITE request from an IP phone 101a, the home gateway A 102a checks the user setup 1025 (not the response state of the SIP server 103a) at Step L301 of FIG. 4. If the transmission destination telephone number of the INVITE request is set in the user setup 1025, the flow will proceed to Step L305 of FIG. 4. If being not set, the flow will proceed to Step L302.

Incidentally, the user setup 1025 may be such that the home gateway 102 is not necessarily maintained. For example, it may be all right that another server device maintains the user setup, and when the home gateway 102 receives the INVITE request from the IP phone 101a, the home gateway 102 inquiries the server device via the network.

Other respects are the same as those of the first embodiment.

According to the second embodiment, a system can be constructed using a network for coupling the gateway and the user agent, without using the SIP server and the network coupling to the SIP server. For example, since the IP telephone system that enables users' calls only using the Internet can be constructed, a low-cost call service can be offered to the users.

Note that the present invention is not limited to the above-mentioned embodiments, but various modifications and applications are possible.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A communication gateway device, comprising:
a storage device that couples to a client device and an SIP server device for managing coupling information of the client device and stores setup information; and
a communication proxy processing unit that, when receiving an INVITE request from the client device to another client device, refers to the setup information including SIP-URI and a contact address of the client device included in a REGISTER request, from the client device to the SIP server device, and forwards the INVITE request to the other client device, the INVITE request being an SIP method for beginning a session, the REGISTER request being an SIP method for registering the client device with the SIP server device.

2. The communication gateway device according to claim 1,
wherein the storage device further stores mapping information in which information about the SIP-URI of the client device included in the REGISTER request and the communication gateway device taking charge of the client device are associated with each other, and
the communication proxy processing unit refers to the mapping information, and in the case where another communication gateway device takes charge of the client device having transmitted the REGISTER request, forwards the REGISTER request to the another communication gateway device.

3. The communication gateway device according to claim 2, wherein when receiving the INVITE request from the client device to the another client device, the communication proxy processing unit refers to the mapping information, and in the case where another communication gateway device takes charge of the another client device, forwards the INVITE request to the another communication gateway device.

4. The communication gateway device according to claim 2,
wherein the storage device further stores state information of the SIP server device, and
when receiving the INVITE request from the client device to the other client device, and the state information does not indicate a congestion state of the SIP server device, the communication proxy processing unit forwards the INVITE request to the SIP server device.

5. The communication gateway device according to claim 4,
wherein, when receiving the INVITE request from the client device to the another client device, if the state information indicates the congestion state of the SIP server device, the communication proxy processing unit refers to the mapping information, and
in the case where the another communication gateway device takes charge of the another client device, forwards the INVITE request to the another communication gateway device.

6. The communication gateway device according to claim 4, wherein, when the communication gateway device forwards an SIP request including the REGISTER request and the INVITE request to the SIP server device, the state information is at least either of the number of waiting response requests each of which is in a state of waiting response to the SIP request being forwarded or an average response time to the SIP request.

7. A relay method in a communication gateway device that couples to a client device and an SIP server device for managing coupling information of the client device via a network,
characterized by:
storing SIP-URI and a contact address of the client device included in a REGISTER request from the client device to the SIP server device in a storage device as cache information, the REGISTER request being an SIP method for registering the client device with the SIP server device; and
referring to the cache information to search for the contact address to be forwarded to of the client device by the SIP-URI when receiving the INVITE request from the client device to another client device, the INVITE request being an SIP method for beginning a session.

8. The relay method according to claim 7,
characterized by: storing further mapping information in which information about the SIP-URI of the client device included in the REGISTER request and a communication gateway device taking charge of the client device are associated with each other in the storage device; and
referring to the mapping information, and
in the case where another gateway device takes charge of the client device having transmitted the REGISTER request, forwarding the REGISTER request to the another communication gateway device.

9. The relay method according to claim 8,
characterized by: storing further state information of the SIP server device in the storage device; and,
when receiving the INVITE request from the client device to another of the client device, if the state information indicates a congestion state of the SIP server device, referring to the mapping information, and in the case where the another communication gateway device takes charge of the another client device, forwarding the INVITE request to the another communication gateway device.

10. The relay method according to claim 9, wherein, when the communication gateway device forwards an SIP request including the REGISTER request and the INVITE request to the SIP server device, the state information is at least either of the number of waiting response requests each of which is in a state of waiting response to the SIP request being forwarded or an average response time to the SIP request.
